(19) United States
(12) Patent Application Publication
(10) Pub. No.: US 2009/0113087 A1
(43) Pub. Date: Apr. 30, 2009

(54) STREAM DATA TRANSFER CONTROL DEVICE

(76) Inventors: Nobuaki Kohinata, Yokohama (JP); Yasushi Nagai, Yokohama (JP); Takeshi Asahi, Yokohama (JP); Shigeki Taira, Yokohama (JP); Keitaro Okasaki, Yokohama (JP); Yuichi Kobayashi, Yokohama (JP)

Correspondence Address: MCDERMOTT WILL & EMERY LLP, 600 13TH STREET, N.W., WASHINGTON, DC, 20005-3096, US

(21) Appl. No.: 12/263,148

(22) Filed: Oct. 31, 2008

(30) Foreign Application Priority Data
Oct. 31, 2007 (JP) 2007-282633

(51) Int. Cl. G06F 3/00

(52) U.S. Cl. 710/60

(57) ABSTRACT

There are provided a stream I/F section 7 adapted to exclusively input/output stream data such as video data or audio data from/to a host section, a non-stream I/F section 5 adapted to input/output non-stream data such as an address, a command, photo data, or text data from/to the host section 3, and a recording medium I/F section 11 adapted to input/output the stream data and the non-stream data to/from a recording medium section 4, and the stream I/F section 7 is provided with transfer control means for controlling the transfer rate of the stream data in accordance with a state of use (availability) of each of a receiving buffer 6 and a transmission buffer 8 provided independently.

### CLAIM OF PRIORITY

The present application claims priority from Japanese application serial no. ______ 2007-297526 filed on Nov. 16, 2007, the content of which is hereby incorporated by reference into this application.

### TECHNICAL FIELD

The present invention relates to digital equipment for consumer and industrial use, and in particular to a stream data processing device provided with a transfer control device adapted to receive and transmit stream data such as video data or music data between a host section and a recording medium section to perform stable recording and reproducing operations.

### BACKGROUND ART

Conventionally, hard disk drives (HDD) have been used as recording means for storing operating systems (OS), application programs, and document data created by the users as peripheral equipment of personal computers (PC). In recent years, since growth in capacity and price-reduction have been in progress, HDD have been becoming adopted to various consumer-use digital equipment such as digital versatile disc (DVD)/HDD recorders, set-top boxes (STB), camcorders, car-navigation systems as recording means for storing stream data such as video data or audio data.

Further, as other recording means, semiconductor flash memories superior in impact resistance, low power consumption operation, and silence to HDD have been becoming used frequently in particular in portable digital equipment such as mobile phones or mobile players, and monitoring camera equipment.

Further, JP-A-2004-39129 discloses recording means provided with a first interface for inputting and outputting general purpose data and a second interface for exclusively inputting and outputting real-time data such as stream data, and connected directly to an encoder or a decoder provided to a host section via the second interface thereby easily transmitting and receiving stream data with the host section.

As shown in FIG. 1, the data recording/reproducing device 201 described in JP-A-2004-39129 is composed of a general-purpose input/output interface (I/F) section 204 compliant with the Advanced Technology Attachment (ATA) standard, a dedicated input/output interface (I/F) section 205, a buffer memory 203, a recording/reproducing control section 206, and a recording medium 207, and the dedicated input/output I/F section 205 performs data transfer with an audio/video (AV) compressor and an AV decompressor provided to the host section 202 using a clock synchronization method or a strobe synchronization method. These methods are generally called handshake method, and the data transfer is performed with a protocol shown in FIG. 2.

As shown in FIG. 2, when the transmission side has transmission data, the transmission side asserts (sets the Req signal to the high state) the Req signal as a data transmission request signal (time T0), and waits until the reception side asserts the Ack signal as a data reception permission. When the reception side is ready for receiving the data, the reception side asserts the Ack signal (time T1). Subsequently, when the transmission side detects that the Ack signal is asserted, the transmission side transmits data (D1, D2, D3, . . . , Dn) on the Data signal. Then, when the transmission of a predetermined amount of data has been completed, the transmission side negates (set the Req signal to the low state) the Req signal to inform the reception side of the completion of the data transmission (time T2).

### DISCLOSURE OF THE INVENTION

### Problems to be Solved by the Invention

Incidentally, according to the handshake method shown in FIG. 2 and disclosed to the dedicated input/output I/F section 205 of the conventional data recording/reproducing device 201, the following problem arises.

Firstly, when the Ack signal from the reception side is negated, the transmission side must negate the Req signal to halt the data transmission even when the data transmission is in progress.

Therefore, since the transmission side is not allowed to ensure the amount of data transmission to the reception side, there is a possibility that the transmission buffer provided to the transmission side overflows to cause data loss. Further, in the case in which the data to be transmitted is stream data, it becomes extremely difficult to ensure the real-time property of the stream data.

On the other hand, when the Req signal from the transmission side is negated, the data transmission is halted in the reception side. Therefore, the reception side is not allowed to ensure the amount of received data, and there is possibility that the receiving buffer provided to the reception side underflows to fail to obtain the necessary amount of data at a desired time point.

As described above, in the handshake method, there arises the problem that the data transfer cannot be ensured although the both sides make confirmation at the start of the data transfer, and therefore, particularly in the case with stream data requiring to ensure the real-time property, there arises a problem that disturbance is caused in reproduced pictures or reproduced sounds.

For example, in FIG. 1, in the case in which a recording operation of transmitting data from the host section 202 to the dedicated input/output I/F section 205 is performed, the data recording/reproducing device 201 is not allowed to receive the data when the Req signal from the host section 202 is not asserted.

Therefore, since the data reception from the dedicated input/output I/F section 205 is not allowed while the recording/reproducing control section 206 writes the data sequentially into the recording medium 207 from the buffer memory 203 in accordance with the bit rate of the data, the buffer memory 203 underflows, thus the recording operation cannot stably be performed.

Further, the host section 202 is not allowed to transmit data unless the Ack signal from the data recording/reproducing device 201 is asserted. Therefore, since the data transmission to the data recording/reproducing device 201 is not allowed while receiving data from a tuner provided to the host section 202 at a constant bit rate, the buffer memory provided to the host section 202 overflows, thus the recording operation cannot be ensured.

Reliability is important particularly to the recording operation of stream data, because if a data loss occurs in the recording operation, the degradation cannot be compensated no matter how surely the reproducing operation is performed.

Then, in the case in which a reproducing operation of transmitting data from the dedicated input/output I/F section 205 to the host section 202 is performed, the data recording/reproducing device 201 must halt the data transmission immediately when the Ack signal of the host 202 is negated irrespective of whether or not the transmission of a desired amount of data is completed.

Therefore, since the data transmission from the dedicated input/output I/F 205 is not allowed while the recording/reproducing control section 206 retrieves the data sequentially from the recording medium 207 in accordance with the bit rate of the data, the buffer memory 203 overflows, thus the reproducing operation cannot stably be performed.

Further, the host section 202 is not allowed to receive data unless the Req signal of the data recording/reproducing device 201 is asserted. Therefore, since the data reception from the data recording/reproducing device 201 is not allowed while a decoder provided to the host section 202 decodes data at a constant bit rate, the buffer memory provided to the host section 202 underflows, thus the reproducing operation cannot be ensured.

Although it is possible to take a measure of increasing the capacities of the buffer memory provided to the host section 202 and the buffer memory 203 provided to the data recording/reproducing device 201 to suppress the overflow and underflow of the buffer memories in order for solving the problems, since the cost and the mounting area are increased, the measure is not suitable for built-in equipment such as digital equipment for consumer and industrial use.

### Means for Solving the Problem

Therefore, in order for solving the problems described above, the present invention has an object of providing a stream data transfer control device capable of performing stable recording and reproducing operations in the digital equipment for commercial and industrial use provided with recording means such as HDD or semiconductor flash memories by transmitting and receiving stream data to and from such recording means in a reliable manner.

A stream data transfer control device according to a first embodiment of the present invention capable of achieving the object described above includes a stream I/F section adapted to exclusively input/output stream data from/to a host section using a receiving buffer and a transmission buffer provided with:

a variable rate stream reception circuit having a reception threshold holding section for storing a threshold value, which is a reception setting parameter provided from the host section and related to a used area (free space) of the receiving buffer described above for controlling the Ack signal used for asking for adjustment of the transmission rate of the stream data in accordance with the amount of used area (free space) of the receiving buffer, a reception bit rate holding section adapted to store the bit rate of the stream data to be received, which is a recoding setting parameter provided from the host section, a receiving buffer free space detection section adapted to detect the used area (free space) of the receiving buffer, a receiving buffer R/W control section looking up the reception bit rate holding section and the receiving buffer free space detection section and instructing writing of the stream data to the receiving buffer and reading of the streaming data from the receiving buffer, a reception comparing section adapted to compare the values of the receiving buffer free space detection section and the reception threshold holding section and issuing a reception control event if the values matches each other, a reception I/F signal control section adapted to control issuance of the Ack signal based on the reception control event, a receiving buffer control section adapted to provide an interface to the receiving buffer in response to an instruction of the receiving buffer R/W control section; and

a variable rate stream transmission circuit having a transmission threshold holding section for storing a threshold value, which is a transmission setting parameter provided from the host section and related to a used area (free space) of the transmission buffer described above for controlling the Req signal as a transmission request of the stream data in accordance with the amount of used area (free space) of the transmission buffer, a transmission bit rate holding section adapted to store the bit rate of the stream data to be transmitted, which is a reproducing setting parameter provided from the host section, a transmission buffer free space detection section adapted to detect the used area (free space) of the transmission buffer, a transmission buffer R/W control section looking up the transmission bit rate holding section and the transmission buffer free space detection section and instructing writing of the stream data to the transmission buffer and reading of the streaming data from the transmission buffer, a transmission comparing section adapted to compare the values of the transmission buffer free space detection section and the transmission threshold holding section and issuing a transmission control event if the values matches each other, a transmission I/F signal control section adapted to control issuance of the Req signal based on the transmission control event and the Ack signal, a transmission buffer control section adapted to provide an interface to the transmission buffer in response to an instruction of the transmission buffer R/W control section.

Further, the stream data transfer control device according to a second embodiment includes a variable rate stream reception circuit having a reception bit rate extraction section adapted to sequentially detect the bit rate from the stream data received instead of the reception bit rate holding section of the variable rate stream reception circuit according to the first embodiment, a variable rate stream transmission circuit having a transmission bit rate extraction section adapted to sequentially detect the bit rate from the stream data received instead of the transmission bit rate holding section of the variable rate stream transmission circuit according to the first embodiment.

Further, the stream data transfer control device according to a third embodiment includes a reception I/F signal control circuit capable of looking up a transmission request size as the amount of data to be transmitted from now which is provided as the stream data, instead of the reception I/F signal control section of the variable rate stream reception circuit according to the first or second embodiment, and a transmission I/F signal control circuit capable of transmitting as the stream data the transmission request size as the amount of data to be transmitted from now, instead of the transmission I/F signal control section of the variable rate stream reception circuit according to the first or second embodiment.

### EFFECT OF THE INVENTION

According to the present invention, the following advantage can be obtained.

According to the stream data processing device provided with the stream data transfer control section of the first embodiment, the reception side asks the transmission side to adjust the transmission rate of the stream data automatically in accordance with the remaining free space of the receiving buffer, and the transmission side, in response thereto, can transmit stream data at a predetermined transmission rate.

Thus, the reception side can receive the stream data in accordance with the condition thereof, and the transmission side can continue transmission without halt, an advantage of making it possible to perform recording and reproducing more reliably while preventing the buffer overflow and the buffer underflow can be obtained.

Further, according to the stream data processing device of the second embodiment, the bit rate of the stream data transmitted or received is recognized automatically, and the information can be reflected to the R/W control section for the receiving buffer and the transmission buffer provided to the stream reception means and the stream transmission means.

Thus, similarly to the advantage obtained by the first embodiment, there can be obtained an advantage that, even the stream data is the variable bit rate data, recording and reproducing can reliably be performed.

Further, according to the stream data processing device related to the third embodiment, it is possible to exchange the amount of transmission (reception) data between the transmission side and the reception side in advance. Thus, it becomes possible to give consideration to the remaining free space of the reception buffer and the transmission buffer, in addition to the advantage obtained by the first and the second embodiments, namely the advantage that the recording and reproducing of the stream data can reliably be performed, an advantage of achieving efficient transfer of the stream data can also be obtained.

### BEST MODE FOR CARRYING OUT THE INVENTION

Hereinafter, some embodiments of the present invention will be described with reference to the accompanying drawings.

### First Embodiment

A first embodiment of the present invention will hereinafter be explained with reference to FIG. 3.

FIG. 3 shows a stream data processing device 1 including a stream data transfer control section 2 disposed between a host section 3 and a recording medium section 4.

Here, the stream data processing device 1 is the digital equipment for commercial and industrial use such as a PC, a DVD/HDD recorder, a camcorder, a mobile phone, a portable music player, or a monitoring camera.

Further, the host section 3 is mainly composed of a host processor for controlling principal operations of the stream data processing device 1, a tuner for receiving digital broadcasting waves, a decoder for decompressing digital data encoded with a predetermined compression method, a display controller for outputting pictures to a display device such as a TV, a network controller for accessing the network, and so on although omitted from the drawing.

Further, the recording medium section 4 is recording means for storing user data such as pictures, music, photos, or documents, OS and middleware for controlling various resources and operations of the digital equipment, further, application programs such as a viewer or a graphical user interface (GUI), and so on, and is formed, for example, of a magnetic disk drive such as HDD, a magneto optical disk drive such as a DVD drive or a Blu-ray Disc drive, or a semiconductor flash memory such as a compact flash (CF) card or an SD card.

Therefore, depending on a specific form of the application of the stream data processing device 1, it is also possible to form the stream data transfer control section 2 as a part of the host section 3 or a part of the recording medium section 4.

The stream data transfer control section 2 is mainly composed of a non-stream I/F section 5, a stream I/F section 7, a controller section 9, a memory 10, a recording medium I/F section 11, and a receiving buffer 6 and a transmission buffer 8 each connected to the stream I/F section 7, and the non-stream I/F section 5, the stream I/F section 7, the controller section 9, the memory 10, and the recording medium I/F section 11 are arranged to be capable of communicating necessary commands and data with each other via a bus 12. Further, the stream data transfer control section 2 interprets various control commands, which are provided from the host section 3 via the non-stream I/F section 5, with the controller section 9, and in accordance with the results, the stream data transfer control section 2 performs the operations such as sequentially storing the stream data input from the host section 3 via the stream I/F section 7 into the recording medium section 4 via the recording medium I/F section 11, or sequentially retrieving the stream data stored in the recording medium section 4 to output the stream data thus retrieved to the host section 3 via the stream I/F section 7.

The stream I/F section 7 provides an interface for inputting/outputting a plurality of stream data such as video data or music data simultaneously from/to the host section 3 while using the receiving buffer 6 and the transmission buffer 8, and is specifically composed mainly of control lines for communicating data transmission requests and data reception permissions, and data lines for communicating compressed digital data of the transport stream (TS) format, the program stream (PS) format, and the time-stamped TS (TTS) format.

The non-stream I/F section 5 provides an interface for inputting/outputting non-stream data other than the stream data such as photos, text data, and further control commands such a as read command or a write command for recording such data on the recording medium 4 from/to the host section 3, and is specifically compliant with a general purpose bus standard such as ATA, CE-ATA as ATA for built-in equipment, Universal Serial Bus (USB), Peripheral Component Interconnect (PCI).

The controller section 9 performs operations such as interpreting the various control commands input from the non-stream I/F section 5 to control the operations of each functional sections, managing attributes of the stream data inputting/outputting via the stream I/F section 7 such as date and time of creation or access control, or determining the locations of the stream data on the recording medium section 4.

The memory 10 is used for storing a software program running on the controller section 9, and for temporarily buffering non-stream data, when the input/output of the non-stream data from/to the host section 3 and the input/output of stream data from/to the host section 3 compete against each other, for processing the stream data with priority, and is formed of a volatile memory such as a dynamic random access memory (DRAM) or a nonvolatile memory such as a flash memory.

The recording medium I/F section 11 provides a physical interface corresponding to the recording medium section 4.

Then, the configuration of the stream I/F section 7 will be explained with reference to FIG. 4. It should be noted that in FIG. 4, only a part of the stream data transfer control section 2 shown in FIG. 3 necessary for explaining the stream I/F section 7 is described.

As shown in FIG. 4, the stream I/F section 7 is mainly composed of a reception control section 22 and a receiving buffer control section 21 both constituting variable rate stream receiving means, a transmission control section 23 and a transmission buffer control section 24 both constituting variable rate stream transmission means, and a bus I/F section 25 as connection means with the bus 12.

The reception control section 22 accepts the Req signal synchronized with the clk_in signal, which is a signal for performing communication with the host section 3 by handshake to control issuance of the Ack signal in accordance with the internal operational state, and issues instructions to the receiving buffer control section 21 such as a writing instruction to for storing the stream data (stream_data_in) input from the host section 3 into the receiving buffer 6, or a reading instruction for transmitting the stream data thus stored to the bus 12 via the bus I/F section 25.

The receiving buffer control section 21 provides an interface for reading/writing the stream data (stream_data_in) in accordance with the writing instruction and the reading instruction from the reception control section 22 so as to meet the physical memory constituting the receiving buffer 6 such as a DRAM of a static random access memory (SRAM).

Reception setting parameters included in a reception setting command provided from the host section 3 via the non-stream I/F section 5 when initializing the stream data processing device, and recording setting parameters included in a recording command provided from the host section 3 via the non-stream I/F section 5 when recording the stream data are extracted and set to the reception control section 22 by the controller section 9, and the reception control section 22 performs the stream reception operation in accordance with these parameters.

It should be noted that although the clock signal (clk_in) is arranged to be an input signal to the reception control section 22 in FIG. 4, it can be an output signal in accordance with the specification of the host section 3 depending on the form of the application.

On the other hand, the transmission control section 23 issues the Req signal, which is a signal line for performing communication with the host section 3 by handshake, in accordance with the internal operational state, accepts the Ack signal synchronized with the clk_out signal, and issues the instructions to the transmission buffer control section 24 for transmitting the stream data (stream_data_out) to the host section 3, such as a writing instruction for storing the stream data input from the bus I/F section 25 into the transmission buffer 8 or a reading instruction for transmitting to the host section 3 the stream data thus stored.

The transmission buffer control section 24 provides an interface for reading/writing the stream data (stream_data_out) in accordance with the writing instruction and the reading instruction from the transmission control section 23 so as to meet the physical memory constituting the transmission buffer 8 such as a DRAM of a SRAM.

Transmission setting parameters included in a transmission setting command provided from the host section 3 via the non-stream I/F section 5 when initializing the stream data processing device, and reproducing setting parameters included in a reproducing command provided from the host section 3 via the non-stream I/F section 5 when reproducing the stream data or delivering the stream data via a network are extracted and set to the transmission control section 23 by the controller section 9, and the transmission control section 23 performs the stream transmission operation in accordance with these parameters.

It should be noted that although the clock signal (clk_out) is arranged to be an output signal to the transmission control section 23 in FIG. 4, it can be an input signal in accordance with the specification of the host section 3 depending on the form of the application.

Further, the data communication between the variable rate stream reception means and the variable rate stream transmission means of the stream I/F section 7 and the recording medium I/F section 11 can be performed by the programmable input/output (PIO) transfer under the initiative of the controller section 9, or can be performed by direct transfer with the direct memory access (DMA) function provided to the bus I/F section 25 without the intervention by the controller section 9.

Then, the configurations of the reception control section 22 and the transmission control section 23 constituting the variable rate stream reception means and the variable rate stream transmission means, respectively, with reference to FIGS. 5 and 6.

Firstly, as shown in FIG. 5, the reception control section 22 is mainly composed of a reception threshold holding section 35 connected to the bus I/F section 35 and for holding threshold values, which are included in the reception setting parameters, and used for determining the control of the Ack signal as means for notifying the transmission side of a transmission rate deceleration instruction, a transmission halt instruction, and a transmission start (resumption) instruction for the stream data to be received based on the extent of the data stored in the receiving buffer 6,

a reception bit rate holding section 36 connected to the bus I/F section 25, and for holding the bit rate value, which is included in the recording setting parameters, and represents the bit rate of the stream data to be thereafter received,

a receiving buffer free space detection section 33 for figuring out the status of use (availability) of the receiving buffer 6 by looking up the read pointer and the write pointer managed by the receiving buffer control section 21, a receiving buffer R/W control section 34 for issuing the writing instruction to the receiving buffer control section 21 in response to the update of the content of the reception bit rate holding section 36 responsive to the commencement of the stream reception operation, and for issuing the reading instruction to the receiving buffer control section 21 for instructing the receiving buffer control section 21 to output the stream data stored in the receiving buffer 6 to the bus I/F section 25 at the bit rate after looking up the receiving buffer free space detection section 33 and the reception bit rate holding section 36, a reception comparing section 32 for comparing the values of the receiving buffer free space detection section 33 and the reception threshold holding section 35 to issue a reception control event to the reception I/F signal control section 31, and the reception I/F signal control section 31 for receiving the Req signal and issuing the Ack signal based on the reception control event.

As an example of the operation of the reception control section 22, in order for issuing the reception control event to the reception I/F signal control section 31 when the receiving buffer 6 becomes ¼ Full, ¾ Full, and Full, respectively, it is possible to issue the reception setting command from the host section so that the values of ¼, ¾, and 1 are set in the reception threshold holding section 35 as the reception setting parameters. Specifically, in the stream reception operation, the reception comparing section 32 compares the threshold values in the reception threshold holding section 35 and the receiving buffer free space detection section 33, and issues reception control events when the both values match each other.

Further, as shown in FIG. 6, the transmission control section 23 is composed mainly of a transmission threshold holding section 43 connected to the bus I/F section 25 and for holding threshold values, which are included in the transmission setting parameters, and for controlling the Req signal as means for notifying the reception side of the amount of data stored in the transmission buffer 8 causing the transmission to start, and of the amount of free space in the transmission buffer 8 causing the transmission to halt, a transmission bit rate holding section 44 connected to the bus I/F section 25, and for holding the bit rate value, which is included in the reproducing setting parameters, and represents the bit rate of the stream data to be thereafter transmitted, a transmission buffer free space detection section 45 for figuring out the status of use (availability) of the transmission buffer 8 by looking up the read pointer and the write pointer managed by the transmission buffer control section 24, a transmission buffer R/W control section 46 for issuing the writing instruction to the transmission buffer control section 24 in response to the update of the content of the transmission bit rate holding section 44 responsive to the commencement of the stream transmission operation, for issuing the reading instruction to the transmission buffer control section 24 for instructing the transmission buffer control section 24 to output the stream data stored in the transmission buffer 8 from the transmission buffer 8 at the bit rate after looking up the transmission buffer free space detection section 45, the transmission bit rate holding section 44, and the transmission I/F signal control section 41, and for adjusting the reading instruction in accordance with the transmission rate deceleration instruction and the transmission halt instruction, a reception comparing section 42 for comparing the values of the transmission buffer free space detection section 45 and the transmission threshold holding section 43 to issue a transmission control event to the transmission I/F signal control section 41, and the transmission I/F signal control section 41 for issuing the Req signal based on the transmission control event and the Ack signal received.

As an example of the operation of the transmission control section 23, in order for issuing the transmission control event to the transmission I/F signal control section 41 when the transmission buffer 8 becomes ¼ Full, it is possible to issue the transmission setting command from the host section so that the value of ¼ is set in the transmission threshold holding section 43 as the transmission setting parameter. Specifically, in the stream transmission operation, the transmission comparing section 42 compares the threshold value in the transmission threshold holding section 43 and the transmission buffer free space detection section 45, and issues transmission control event when the both values match each other.

Hereinafter, the operation of the reception I/F signal control section 31 shown in FIG. 5 will additionally be explained with reference to FIGS. 7 and 8.

As shown in FIG. 7, the reception I/F signal control section has a state machine provided with three states, namely normal receiving 51, decelerated receiving 52, and receiving halt 53, and makes the transitions between the states in accordance with the reception control events to control asserting and negating of the Ack signal.

Firstly, in the initialization executed, for example, immediately after powering on, if the Req signal is asserted, the reception I/F signal control section 31 asserts the Ack signal, and starts from the state of normal receiving 51.

In the state of normal receiving 51, when receiving the reception control event of ¾ Full, the reception I/F signal control section 31 negates the Ack signal for 1 cycle, and then makes the transition to the state of decelerated receiving 52.

In the state of decelerated receiving 52, when receiving the reception control event of Full, the reception I/F signal control section 31 negates the Ack signal for 2 or more cycles, and then makes the transition to the state of receiving halt 53. Further, in the state of deceleration receiving 52, when receiving the reception control event of ¼ Full, the reception I/F signal control section 31 negates the Ack signal again for 1 cycle, and then makes the transition to the state of normal receiving 51.

In the state of receiving halt 53, when receiving the reception control event of ¼ Full, the reception I/F signal control section 31 asserts the Ack signal, and then makes the transition to the state of normal receiving 51.

FIG. 8 is for explaining an example of the communication protocol of the reception control section in response to the variation in the used area (free space) in the receiving buffer.

As shown in FIG. 8, firstly at the time T0, the reception control section confirms that the Req signal is asserted, and asserts the Ack signal to start receiving the stream data. Subsequently, since a sufficient free space remains in the buffer in the period A, the reception is executed at the bit rate of the transmission of the host section, namely, the bit rate of the stream data.

Then, since the receiving buffer reaches ¾ Full at the time T1, the reception control section negates the Ack signal for 2 cycles to ask the host section to perform the decelerated transmission. Upon detection of this procedure, the host section transmits the stream data, which is transmitted every cycle in the normal receiving state, in every 2 cycles, for example, thus the reception is performed at a rate decelerated to be a half as high as the normal rate during the period B. If the receiving buffer reaches Full at the time T2 even by the decelerated reception, the reception control section completely negates the Ack signal to instruct the host section to halt the transmission, and the host section, which has received the instruction, halts the transmission during the period C. Further, when the receiving buffer reduces to ¼ Full at the time T3 after a predetermined period of time has elapsed, the reception control section asserts the Ack signal again to start receiving the stream data in the normal receiving state.

Further, it is also possible that the stream data is transmitted every 2 cycles in the normal receiving state, in the decelerated receiving state, the stream data is transmitted every 3 cycles, and further, in a accelerated receiving state, which is provided additionally, the stream data is transmitted every cycle. Further, in this case, it is also possible to compensate the penalty in the decelerated receiving state with the accelerated receiving state thereby easily ensuring the bit rate.

Hereinabove, the first embodiment of the invention is described. According to the present embodiment, since the reception side ask the transmission side to control the transmission rate of the stream data dynamically in accordance with the amount of the remaining free space of the receiving buffer, and the transmission side, in response thereto, can transmit the stream data at a predetermined transmission rate, the reception side can receive the stream date in accordance with the state of the receiving buffer, and the transmission side can also continue transmission without halting the transmission. Therefore, it becomes possible to reliably perform the transmission/reception of the stream data while preventing the buffer overflow and the buffer underflow.

### Second Embodiment

A second embodiment of the present invention will hereinafter be explained with reference to FIG. 9.

The stream data I/F section 61 shown in FIG. 9 is different from the stream I/F section 7 shown in FIG. 4 in that the stream data I/F section 61 inputs the stream data (stream_data_in) thus received not only to the receiving buffer control section 21 but also to the reception control section 62. Further, they are different from each other in that the stream data (stream_data_out) to be transmitted is input from the bus I/F section 25 not only to the transmission buffer control section 24 but also to the transmission control section 63.

When initializing the stream data processing device, the controller section 9 sets the reception setting parameters included in the reception setting command provided from the host section 3 via the non-stream I/F section 5 to the reception control section 62, and the reception control section 62 for itself extracts the recording parameters from the parameters described in the stream data and the configuration of the stream data and holds the recording parameters when recording the stream data, and the reception control section 62 performs the stream reception operation in accordance with these parameters.

Further, when initializing the stream data processing device, the controller section 9 sets the transmission setting parameters included in the transmission setting command provided from the host section 3 via the non-stream I/F section 5 to the transmission control section 63, and the transmission control section 63 for itself extracts the reproducing parameters from the parameters described in the stream data and the configuration of the stream data and holds the reproducing parameters when reproducing the stream data or delivering the stream data via a network, and the transmission control section 63 performs the stream transmission operation in accordance with these parameters.

Then, the configurations of the reception control section 62 and the transmission control section 63 constituting the variable rate stream reception means and the variable rate stream transmission means, respectively, with reference to FIGS. 10 and 11.

The reception control section 62 shown in FIG. 10 is different from the reception control section 22 shown in FIG. 5 in that the reception control section 62 is provided with a reception bit rate extraction section 71 instead of the reception bit rate holding section 36 of the reception control section 22.

The reception bit rate extraction section 71 is a constituent for extracting and holding the recording parameters, and specifically has a configuration of sampling the timestamp described in the stream data (stream_data_in) thus received and the amount of stream data in a predetermined period, thereby dynamically extracting the bit rate. It should be noted that the reception bit rate extraction section 71 is arranged to look up the reception I/F signal control section 31, and perform the sampling only in the normal receiving state.

Further, the transmission control section 63 shown in FIG. 11 is different from the transmission control section 23 shown in FIG. 6 in that the transmission control section 63 is provided with a transmission bit rate extraction section 81 instead of the transmission bit rate holding section 44 of the transmission control section 23.

As described hereinabove, according to the second embodiment of the present invention, since it is possible to automatically recognize the bit rate of the stream data transmitted/received, and to reflect the information to the R/W control sections corresponding to the receiving buffer and the transmission buffer provided to the stream reception means and the stream transmission means, respectively, even in the case with the stream data with a variable bit rate, transmission/reception of the stream data can reliably be performed while preventing the buffer overflow and the buffer underflow.

### Third Embodiment

A third embodiment of the present invention will hereinafter be explained with reference to FIGS. 12 and 13.

The reception control section 91 shown in FIG. 12 is different from the reception control section 62 shown in FIG. 10 in that the reception control section 91 inputs the stream data (stream_data_in) thus received further to the reception I/F signal control section 92.

Further, the transmission control section 101 shown in FIG. 13 is different from the transmission control section 63 shown in FIG. 11 in that the transmission control section 101 forms the stream data (stream_data_out) to be transmitted while switching between the output data from the transmission I/F signal control section 102 and the stream data from the transmission buffer control section 24 by a selector 103.

The reception I/F signal control section 92 of the reception control section 91 shown in FIG. 12 is provided with a configuration of obtaining a transmission request size describing an amount of data to be transmitted from now provided as the stream data (stream_data_in) at the same time as assertion of the Req signal prior to the stream reception operation, and then looking up the amount of used area (free space) in the reception buffer 6 in the receiving buffer free space detection section 33 to issue the Ack signal if the data corresponding to the transmission request size can be received.

Further, the transmission I/F signal control section 102 of the transmission control section 101 shown in FIG. 13 looks up the transmission buffer free space detection section 45 to determine the transmission request size prior to the stream transmission operation, outputs the transmission request size to the selector 103 at the same time as assertion of the Req signal, and the selector 103 switches to select the input from the transmission I/F signal control section 102 at the assertion of the Req signal to output the transmission request size as the stream data (stream_data_out).

Further, an example of the communication protocol thereof will be explained with reference to FIG. 14. When the transmission data exists, the transmission side asserts the Req signal as a data transmission request at the time T0, and further, transmits the transmission request size S0 at the same timing, and then waits for the Ack signal as a data reception permission from the reception side. The reception side detects the Req signal and the transmission request size S0, and if the data corresponding to the transmission request size S0 can be received, the reception side asserts the Ack signal at the time T1. Upon detection of the assertion of the Ack signal, the transmission side starts data transmission, and when the transmission of the data corresponding to the data size S0 is completed, the transmission side negates the Req signal at the time T2 to notify the reception side of the completion of the transmission.

As described hereinabove, according to the third embodiment of the invention, since the amount of transmission (reception) data can previously be exchanged between the transmission side and the reception side, it becomes possible to give consideration to the remaining free space of each of the receiving buffer and the transmission buffer, the transfer of the stream data can more reliably be performed.

### BRIEF DESCRIPTION OF THE DRAWINGS

FIG. 1 is a configuration diagram of a conventional data recording/reproducing device.

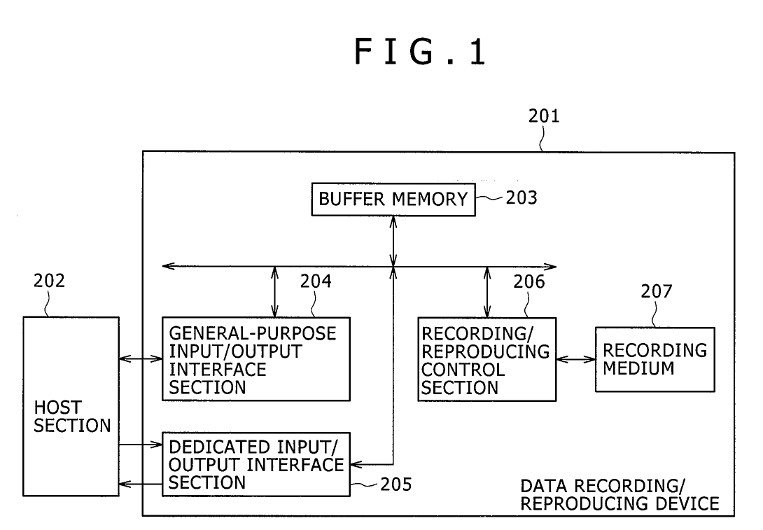

FIG. 2 is a diagram showing a protocol in the conventional stream I/F.

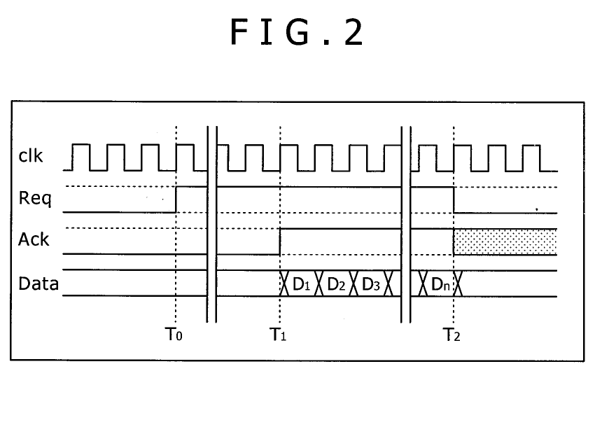

FIG. 3 is a configuration diagram of a stream data processing device and a stream data transfer control section according to an embodiment of the present invention.

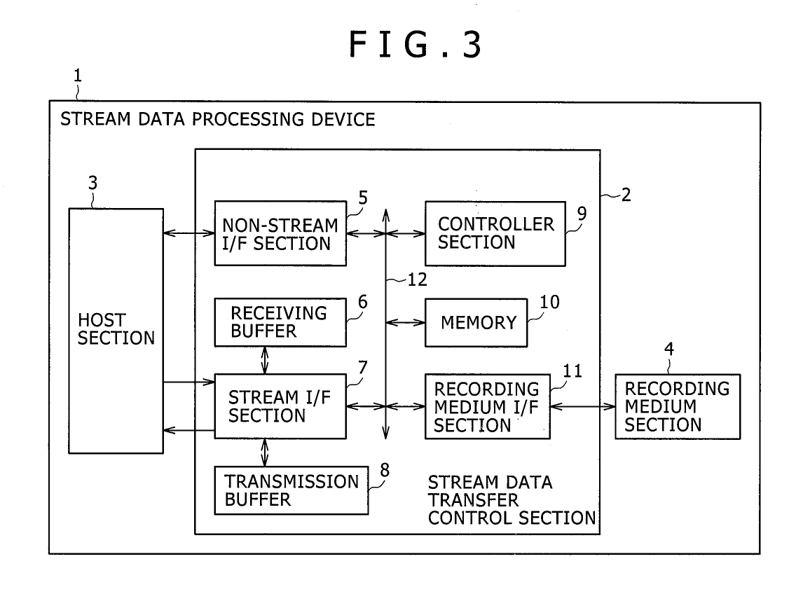

FIG. 4 is a configuration diagram of a stream I/F section according to a first embodiment of the invention.

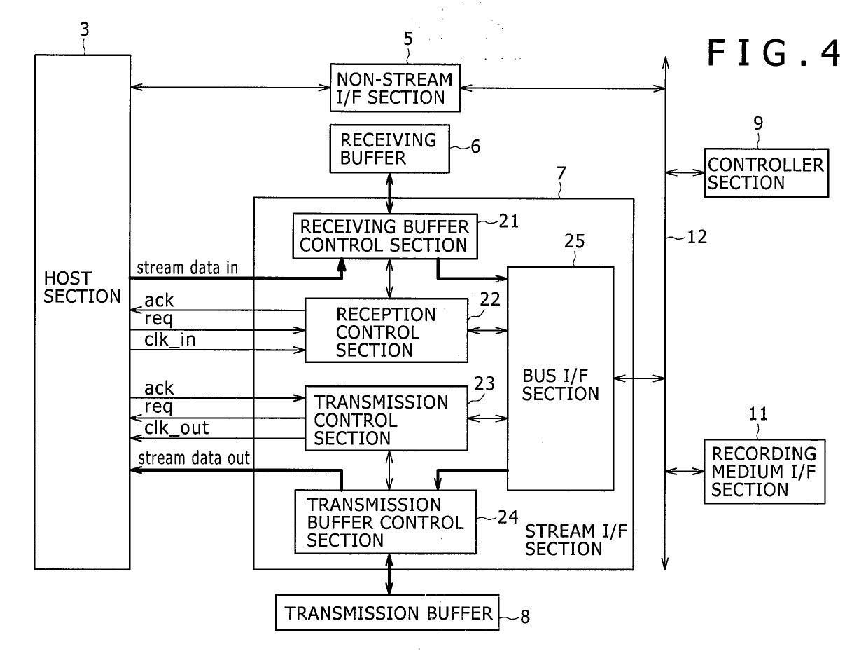

FIG. 5 is a configuration diagram of a reception control section according to the first embodiment of the invention.

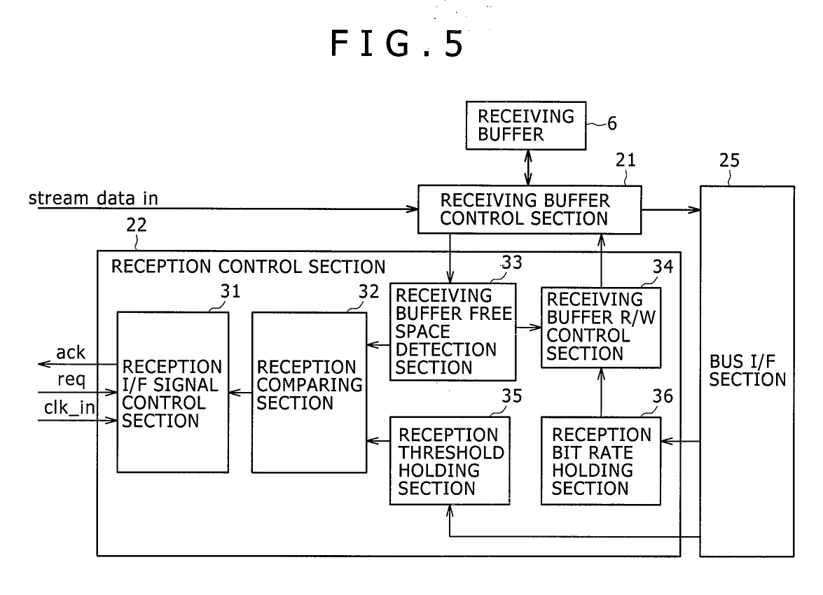

FIG. 6 is a configuration diagram of a transmission control section according to the first embodiment of the invention.

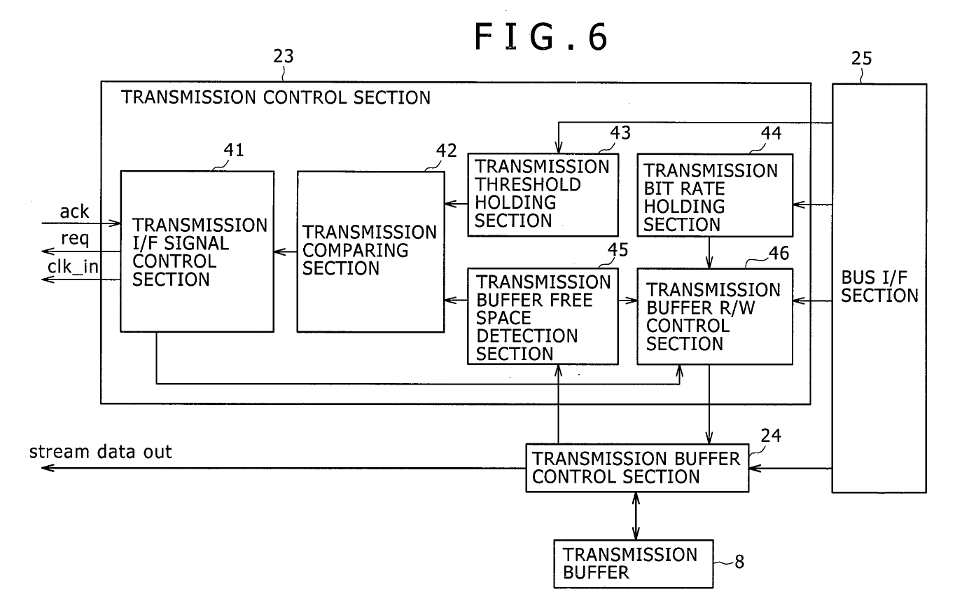

FIG. 7 is a diagram for explaining the states of the reception control section according to the first embodiment of the invention.

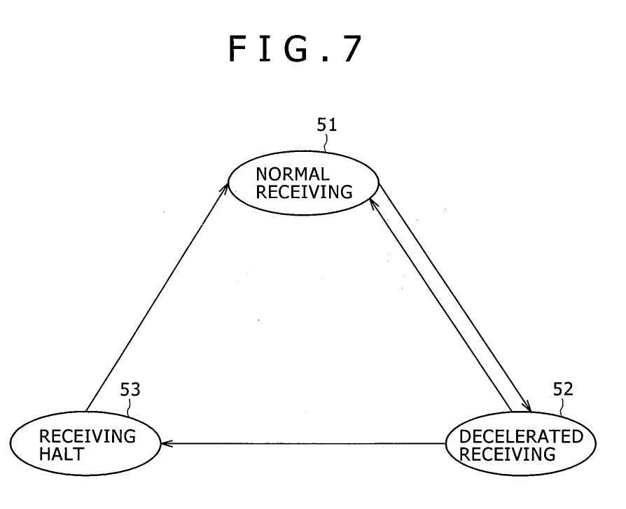

FIG. 8 is a diagram showing a protocol of the stream I/F section according to the first embodiment of the invention.

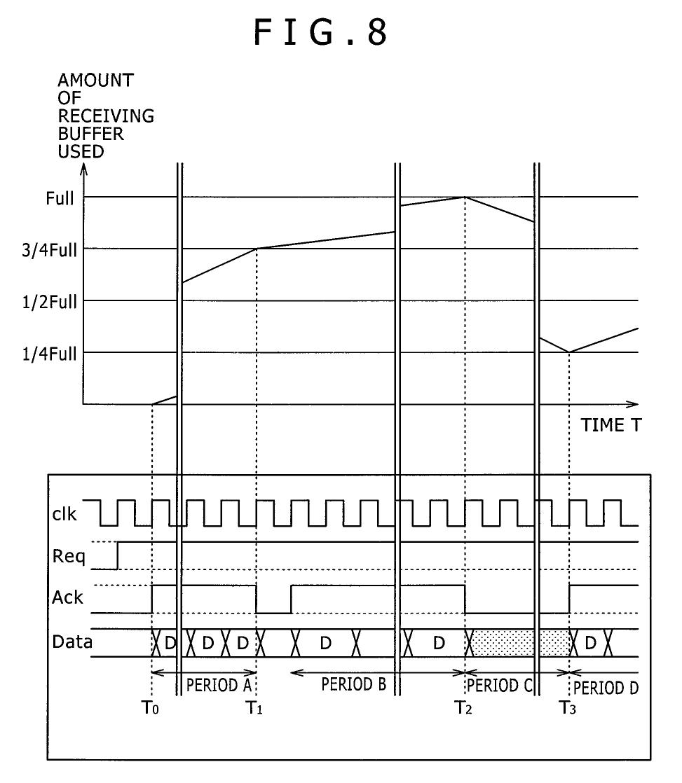

FIG. 9 is a configuration diagram of a stream I/F section according to a second embodiment of the invention.

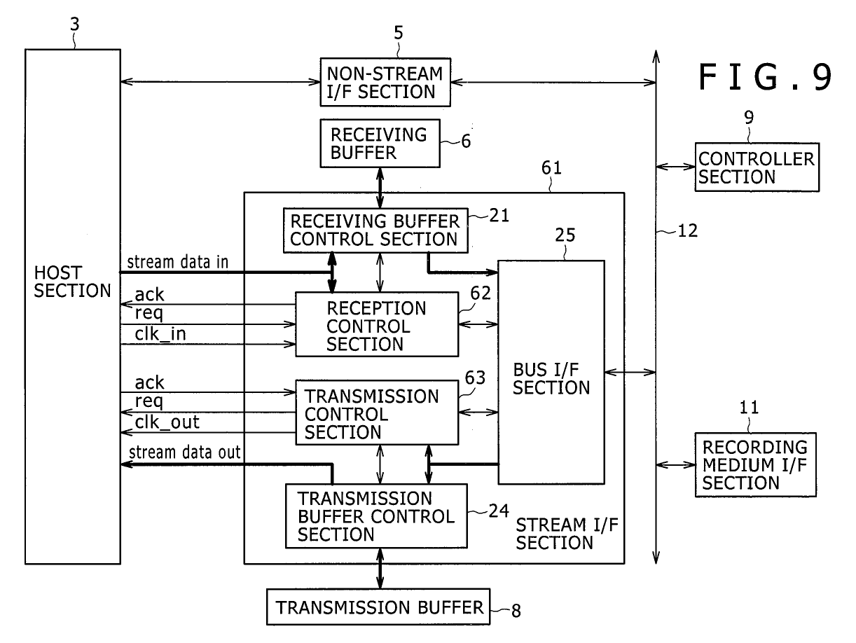

FIG. 10 is a configuration diagram of a reception control section according to the second embodiment of the invention.

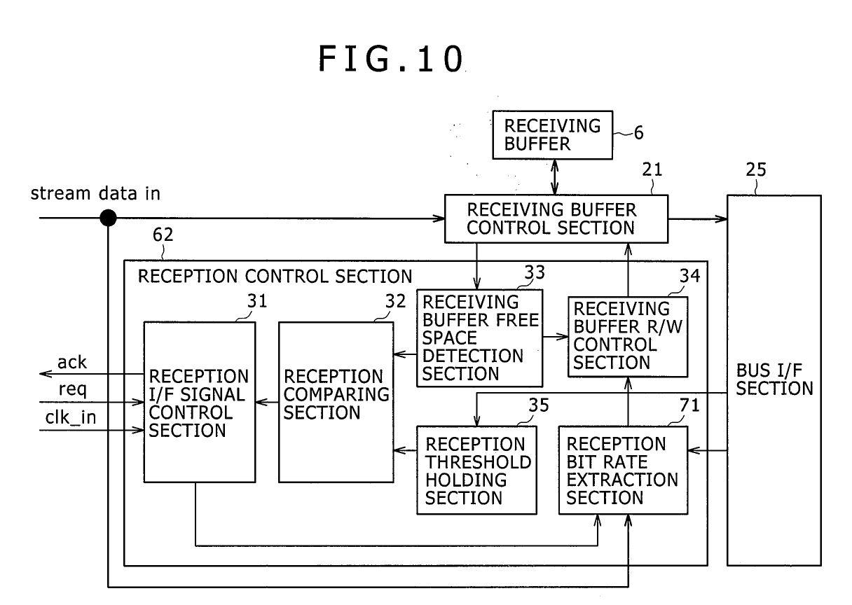

FIG. 11 is a configuration diagram of a transmission control section according to the second embodiment of the invention.

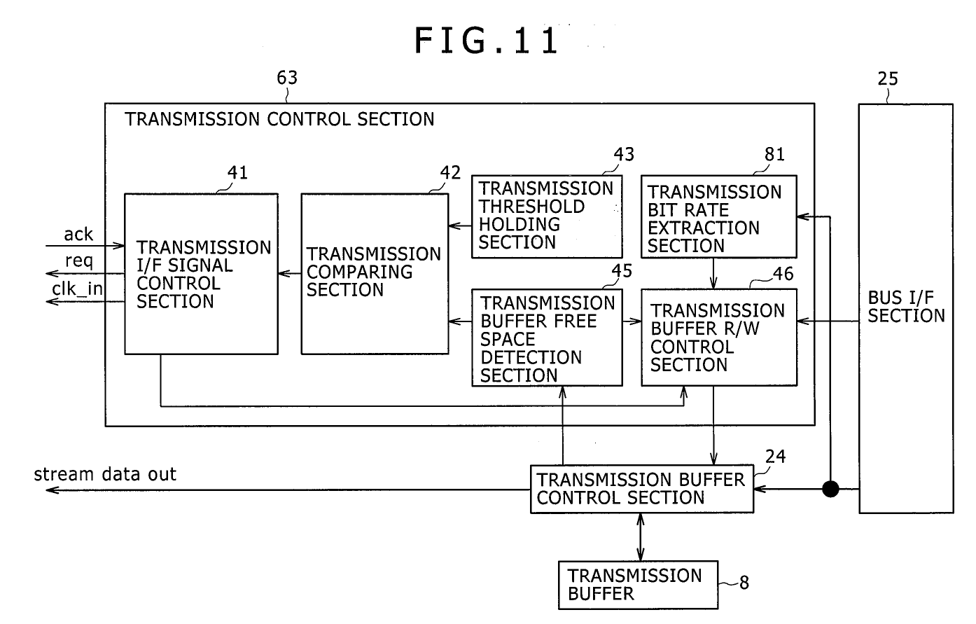

FIG. 12 is a configuration diagram of a reception control section according to a third embodiment of the invention.

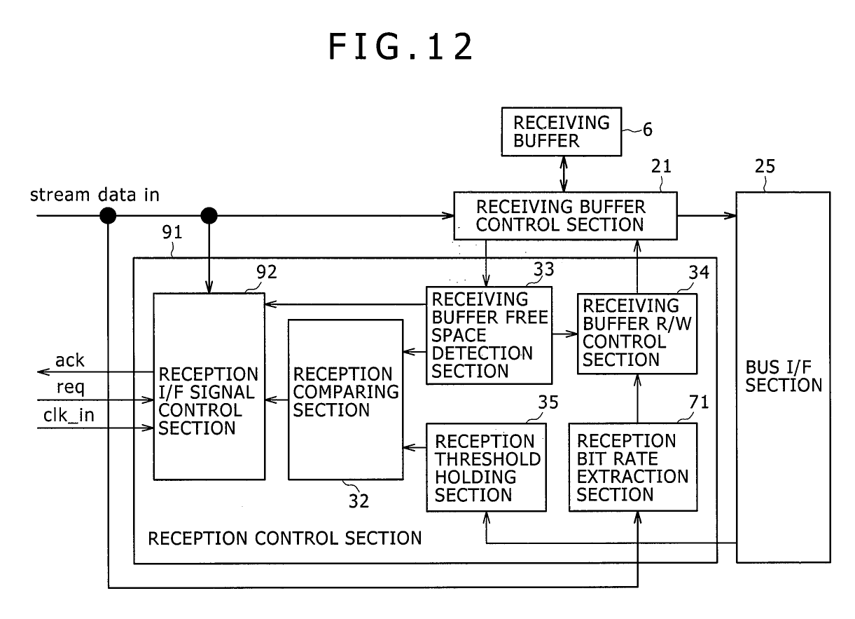

FIG. 13 is a configuration diagram of a transmission control section according to the third embodiment of the invention.

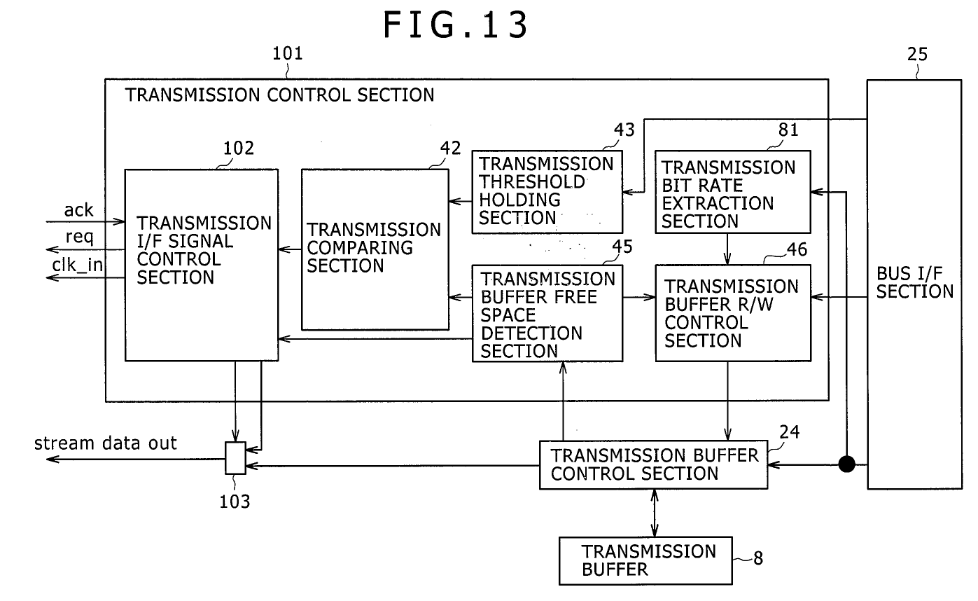

FIG. 14 is a diagram showing a protocol of the stream I/F section according to the third embodiment of the invention.

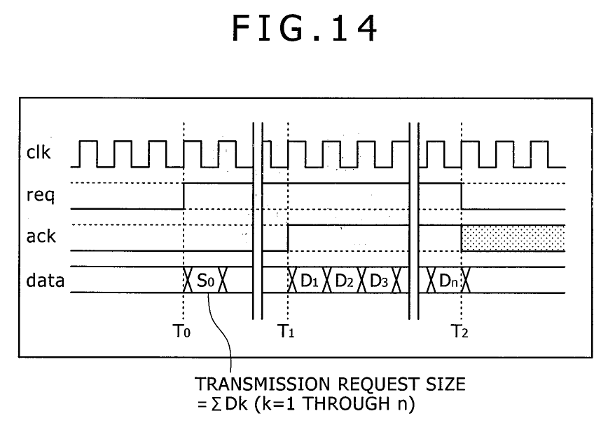

### DESCRIPTION OF REFERENCE NUMERALS AND SIGNS

1: stream data processing device
2: stream data transfer control section
3: host section
4: recording medium section
5: non-stream I/F section
6: receiving buffer
7: stream I/F section
8: transmission buffer
9: controller section
10: memory
11: recording medium I/F section
12: bus
21: receiving buffer control section
22: reception control section
23: transmission control section
24: transmission buffer control section
25: bus I/F section
31: reception I/F signal control section
32: signal comparing section
33: receiving buffer free space detection section
34: receiving buffer R/W control section
35: reception threshold holding section
36: reception bit rate holding section
41: transmission I/F signal control section
42: transmission comparing section
43: transmission buffer free space detection section
44: transmission buffer R/W control section
45: transmission threshold holding section
46: transmission bit rate holding section
51: normal receiving
52: deceleration receiving
53: receiving halt
61: stream I/F section
62: reception control section
63: transmission control section
71: reception bit rate extraction section
81: transmission bit rate extraction section
91: reception control section
92: reception I/F signal control section
101: transmission control section
102: transmission I/F signal control section
103: selector
201: data recording/reproducing device
202: host section
203: buffer memory
204: general purpose input/output interface section
205: dedicated input/output interface section
206: recording/reproducing control section
207: recording medium

1. A stream data transfer control device comprising:
a first interface adapted to exclusively input/output stream data such as video data or audio data from/to a host device;
a second interface adapted to input/output non-stream data such as an address, a command, photo data, or text data from/to the host device; and
a third interface adapted to input/output the stream data and the non-stream data to/from a recording medium,
wherein the first interface is provided with a transfer control circuit adapted to vary a transmission/reception rate of the stream data in accordance with a usage state of each of a buffer memory for reception stream and a buffer memory for transmission stream provided independently from each other.

2. The stream data transfer control device according to claim 1, wherein
the first interface is composed mainly of
a Req signal as a data transmission request issued from a transmission side to a reception side,
an Ack signal as a data reception permission issued from the reception side to the transmission side, and
a Data signal adapted to transfer the stream data from the transmission side to the reception side.

3. The stream data transfer control device according to claim 2, wherein
the transfer control circuit compares the usage state of each of the buffer memory for the reception stream and the buffer memory for transmission stream with at least one threshold value provided by the host device, thereby determining whether or not the transmission/reception rate of the stream data should be changed.

4. The stream data transfer control device according to claim 3, wherein
a notification is made using the Ack signal when the transmission/reception rate of the stream data is changed.

5. The stream data transfer control device according to claim 4, wherein
the transfer control circuit is provided with a bit rate storage device adapted to hold the bit rate of each of the reception stream and the transmission stream, and controls timing for reading of the buffer for the reception stream and timing for writing of the buffer for the transmission stream, based on the bit rate, from a recording medium.

6. The stream data transfer control device according to claim 5, wherein
the bit rate storage device holds the bit rate provided from the host device via the second interface and the bit rate automatically detected from at least one of the reception stream and the transmission stream.

7. The stream data transfer control device according to claim 1, wherein
in the transfer control circuit, prior to the transmission/reception of the stream data, the transmission side informs the reception side of a desired transmission size using the Data signal, and the reception side determines whether or not data having a size corresponding to the desired transmission size can be received.
